(19) United States
(12) Patent Application Publication
(10) Pub. No.: US 2026/0217203 A1
(43) Pub. Date: Jul. 30, 2026

(54) Flat surface tambour cover

(71) Applicant: KTX GmbH, Solingen (DE)

(72) Inventor: Uwe Schulz, Wuppertal (DE)

(73) Assignee: KTX GmbH, Solingen (DE)

(21) Appl. No.: 19/460,451

(22) Filed: Jan. 27, 2026

(30) Foreign Application Priority Data
Jan. 29, 2025 (DE) 10 2025 103 278.5

(51) Int. Cl. B60R 13/02; B32B 3/08; B32B 27/08; B32B 27/36; B60R 5/00

(52) U.S. Cl. CPC B60R 13/02; B32B 3/085; B32B 27/08; B32B 27/365; B60R 5/00; B32B 2307/51; B32B 2307/7376; B32B 2605/00

(57) ABSTRACT

A tambour cover for an interior of a vehicle includes a cover layer (4), a carrier layer (6), and ribs (8). The ribs (8) are lined up parallel to and at a distance (a1) from one another. The cover layer (4) is arranged on a first side (10) of the carrier layer (6). The ribs (8) are arranged on a second side (12) of the carrier layer (6) facing away from the first side (10). The carrier layer (6) includes a soft plastic, and the ribs (8) include a harder plastic than the soft plastic of the carrier layer (6).

### CROSS-REFERENCE TO RELATED APPLICATION

This application claims the benefit of German Patent Application DE 10 2025 103 278.5, filed on Jan. 29, 2025, the content of which is hereby incorporated in its entirety.

### TECHNICAL FIELD

The present disclosure relates to a tambour cover for an interior of the vehicle. The disclosure furthermore relates to a vehicle having such a tambour cover.

### BACKGROUND

The visual appearance, the feel, the craftsmanship and the functionality of the interior of a vehicle is of significance in respect of the perception of quality of the vehicle as a whole for people being conveyed.

Thus, firstly, a great range of functions is expected in the interior of a vehicle, i.e. a multiplicity of storage places, compartments, holders, screens, operating elements, switches, etc., in order to permit comfortable travel. Secondly, the intention is to provide as tidy and clear an appearance of the interior as possible.

One approach to achieving a tidy, clear appearance of the interior is to design the storage spaces, compartments, holders, screens, operating elements, switches, etc., which are mentioned by way of example, to be retractable and extendable so that they protrude only during use. Another possibility consists in designing the storage spaces, compartments, holders, screens, operating elements, switches, etc., which are mentioned by way of example, to be coverable, so that they may be covered, for example, by a tambour cover. Such a tambour cover also protects the covered region in question from dirt and/or mechanical damage.

The above-discussed requirement for a visual appearance which is as pleasing as possible applies even for the tambour cover. The tambour cover is intended to be inserted as seamlessly as possible into the appearance of the surrounding decorative or functional surfaces. In addition, for all of the components of an interior of a vehicle, the intention is that, as far as possible, they should be easy to take care of and to clean.

### SUMMARY

The present disclosure is based on the technical problem of specifying an improved tambour cover for a vehicle which in particular has an attractive visual appearance and should be easy to take care of and to clean. Furthermore, the intention is to specify a vehicle having such a tambour cover.

The above-described technical problem is in each case solved by the features of the independent claims. Further refinements emerge from the dependent claims and the description below.

According to a first aspect, the disclosure relates to a tambour cover for an interior of a vehicle, the tambour cover comprising: a cover layer, a carrier layer, and ribs, the ribs being lined up parallel to and at a distance from one another, the cover layer being arranged on a first side of the carrier layer, the ribs being arranged on a second side of the carrier layer facing away from the first side, the carrier layer comprising a soft plastic, and the ribs comprising a harder plastic than the soft plastic of the carrier layer.

Investigations by the applicant have shown that the use of a cover layer which is placed directly on the ribs leads to the ribs standing out on the surface of the cover layer, or to the cover layer fitting tightly to the ribs in such a way that the ribs can be seen in the region of the visible side which faces an operator in the fully assembled state. This interferes with the visual appearance of the cover layer. In addition, it was not possible to achieve a permanently reliable adhesion of the cover layer to the hard plastic of the ribs.

Investigations by the applicant have also shown that solely the use of the carrier layer with the ribs, without said carrier layer being laminated with a cover layer, leads in turn to the ribs standing out so that the ribs can be seen in the region of the visible side which faces an operator in the fully assembled state.

The arrangement of the carrier layer between the cover layer and the ribs permits a continuously smooth, interruption-free look of the cover layer such that the ribs cannot be seen and do not stand out on the surface of the cover layer. In addition, reliable adhesion of the cover layer to the soft carrier layer can be ensured.

The cover layer may have a smooth visible surface. The visible surface may be matte or highly glossy. The visible surface may have form a profiled or haptic surface, e.g. for simulating a wood grain. The visible surface may accordingly have texture, graining or contouring.

The ribs may be arranged at equidistant distances with respect to one another.

For a plurality of the ribs or for each rib of the ribs, each individual rib may have a longitudinal extent which is oriented perpendicularly to a direction of displacement of the tambour cover.

The cover layer may have a thickness, selected from a range of 0.1 mm to 1.5 mm, in particular selected from a range of 0.1 mm to 1 mm, further in particular selected from a range of 0.25 mm to 0.5 mm.

The carrier layer may have a thickness, selected from a range of 0.5 mm to 1.5 mm, in particular selected from a range of 0.8 mm to 1.5 mm.

Investigations by the applicant have shown that, particularly for a carrier layer thickness greater than or equal to 0.8 mm, it is possible to prevent the ribs from showing through in the cover layer.

The ribs may have a thickness, selected from a range of 4 mm to 15 mm.

Provision may be made for a thickness of the carrier layer to correspond to at least twice the thickness of the cover layer and to correspond to at most ten times the thickness of the cover layer, in particular to correspond to at most five times the thickness of the cover layer.

Alternatively or in addition, provision may be made for a thickness of the ribs to correspond to at least twice the thickness of the carrier layer and to correspond to at most ten times the thickness of the carrier layer, in particular to correspond to at most five times the thickness of the carrier layer.

Where a thickness is discussed here, it is measured perpendicularly to a length and a width of the tambour cover in the unwound state.

Where an unwound state is discussed here, this means that that region of the tambour cover which is in the unwound state lies flat such that the upper side of the cover layer forms a plane, the carrier layer likewise lies flat in this region, and the ribs are lined up along a plane in this region.

Where a wound-up state is discussed here, this means that that region of the tambour cover which is in the wound-up state does not lie flat and is bent at least in some sections such that the upper side of the cover layer forms a curved surface, the carrier layer is likewise curved in this region, and the ribs are lined up along a curved surface in this region.

The cover layer may be a cover film.

The cover layer may comprise a polycarbonate or consist of a polycarbonate. Provision may be made for the cover layer to comprise one or more of the plastics listed below or to consist of one or more of the plastics listed below: polyethylene, polypropylene, polyvinyl chloride, polylactides or polyethylene terephthalate.

The top layer may comprise leather, imitation leather, synthetic leather, alcantara, velour, or other decorative layers.

The cover layer and/or the carrier layer may be elastically and reversibly deformable.

Provision may be made for the ribs to be inelastic and not reversibly deformable.

The cover layer and the carrier layer may be adhesively bonded to each other. The cover layer and the carrier layer may be connected to each other with an integral bond, in particular by injection molding.

The ribs and the carrier layer may be connected to each other with an integral bond, in particular may be injection molded.

Provision may be made for the ribs to comprise one or more of the plastics listed below or to consist of one or more of the plastics listed below: acrylonitrile-butadiene-styrene copolymer; polycarbonate; polyamide; and/or for the ribs to comprise a fiber reinforced plastic or to be made from a fiber reinforced plastic, such as a glass fiber reinforced plastic, a carbon fiber reinforced plastic or the like.

Provision may be made for the ribs to have a cross section which tapers in a direction pointing away from the cover layer and the carrier layer, in particular for the ribs to have a substantially trapezoidal cross section.

The ribs may have, at ends facing away from each other, guide sections protruding beyond a width of the cover layer and the carrier layer, the guide sections being provided for form-fitting engagement in mutually opposite guide grooves formed in the interior of the vehicle.

The carrier layer may comprise a thermoplastic or may consist of a thermoplastic.

According to a second aspect, the disclosure relates to a vehicle, having an interior for receiving people to be conveyed, the interior having at least one coverable region, such as a storage place, a compartment, a holder, a window, a screen, an operating element or the like, having a displaceable, windable tambour cover for covering the at least one coverable region, the tambour cover being displaceable from an open, at least partially wound up position into a closed, at least partially unwound position, the tambour cover being designed in the manner according to the disclosure.

The vehicle may be, for example, a motor vehicle, such as a passenger car, a truck or the like. The vehicle may be, for example, a rail-bound vehicle, such as a passenger train or the like. The vehicle may be an aircraft, such as an air plane or the like.

### BRIEF DESCRIPTION OF THE DRAWINGS

The invention will be explained in more detail below with reference to a drawing illustrating exemplary embodiments. In the drawing, in each case schematically:

FIG. 1 shows a perspective view of a tambour cover in an unwound state;

FIG. 2 shows a partial cross section of the tambour cover from FIG. 1;

FIG. 3 shows the tambour cover from FIG. 1 in a top view;

FIG. 4 shows the tambour cover from FIG. 1 in a front view;

FIG. 5 shows the tambour cover from FIG. 1 with a wound-up region and an unwound region;

FIG. 6 shows a detail of an interior of a vehicle having a tambour cover.

### DETAILED DESCRIPTION

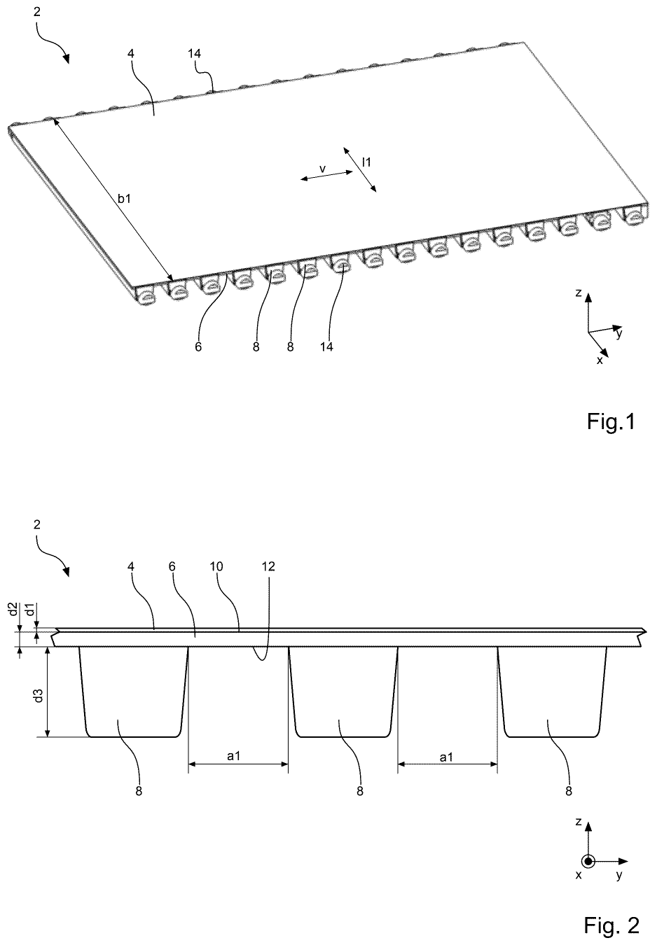

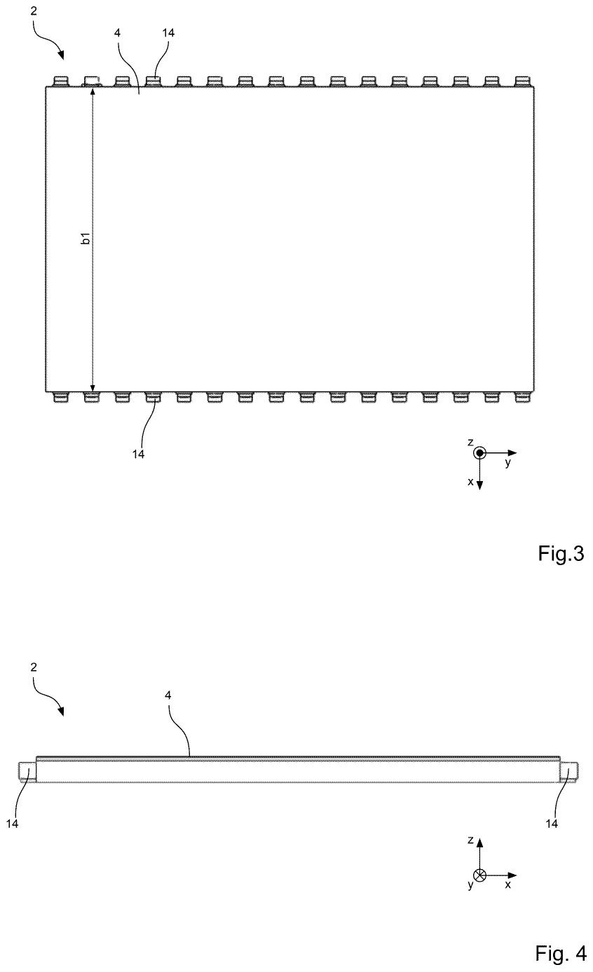

FIG. 1 shows a perspective view of a tambour cover 2 in an unwound state. The tambour cover 2 has a cover layer 4, which cover layer 4 is a cover film 4, a carrier layer 6 and ribs 8. The ribs 8 are lined up in parallel to and at a distance from one another.

For better clarity of the explanations below, a Cartesian system of coordinates x, y, z is introduced.

The cover layer 4 is arranged on a first side 10 of the carrier layer 4. The ribs 8 are arranged on a second side 12 of the carrier layer 6 facing away from the first side 10.

The carrier layer 4 consists of a soft plastic. The ribs 8 consist of a harder plastic than the soft plastic of the carrier layer.

The ribs 8 are arranged at equidistant distances a1 from one another. The distance a1 may be, for example, between 5 mm and 10 mm.

Each rib 8 has a longitudinal extent l1 parallel to the x direction which is oriented perpendicular to a direction of displacement v of the tambour cover 2, the direction of displacement of the tambour cover 2 being oriented parallel to the y direction.

The cover layer 4 has a thickness d1, selected from a range of 0.25 mm to 0.5 mm.

The carrier layer 6 has a thickness d2, selected from a range of 0.2 mm to 1 mm.

The ribs 8 have a thickness d3, selected from a range of 4 mm to 15 mm.

In the unwound state, the respective thickness d1, d2, d3 is measured parallel to the z direction.

The cover layer 4 consists of a polycarbonate.

The carrier layer 6 consists of a thermoplastic.

The ribs 8 consist of one material or of a plurality of materials, selected from: acrylonitrile-butadiene-styrene copolymer; polycarbonate; polyamide - with it being possible for the materials to be fiber reinforced.

The cover layer 4 and the carrier layer 6 are elastically and reversibly deformable. The ribs 8 are inelastic and are not reversibly deformable.

The cover layer 4 and the carrier layer 6 are adhesively bonded to each other.

The ribs 8 and the carrier layer 8 are connected to each other with an integral bond, specifically by injection molding.

As can be gathered from FIG. 2, the ribs 8 have a cross section which is tapered in a direction pointing away from the cover layer 4 and the carrier layer 6. The ribs 8 have a substantially trapezoidal cross section.

The ribs have, at ends facing away from each other, guide sections 14 protruding beyond a width b1 of the cover layer 4 and the carrier layer 6. The guide sections 14 are provided for form-fitting engagement in mutually opposite guide grooves formed in the interior of a vehicle.

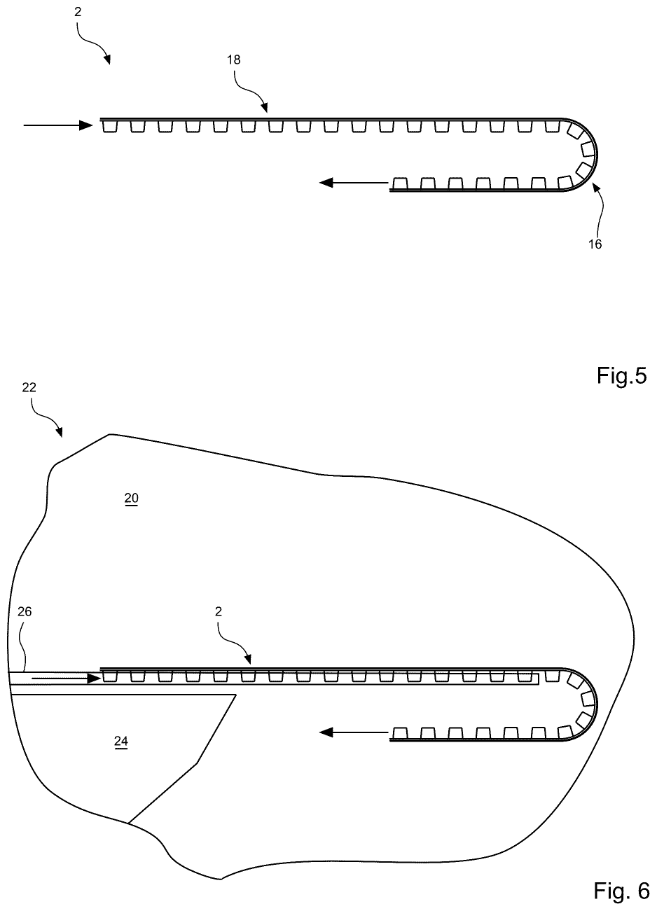

FIG. 5 shows the tambour cover 2 from FIG. 1 with a wound-up region 16 and an unwound region 18. Within the meaning of this application, “wound-up” may mean the bending of the tambour cover 2, as shown in FIG. 5, without winding in multiple layers around a winding shaft or winding axle, or may mean winding-up in multiple layers, with winding in multiple layers around a winding shaft or winding axle taking place.

FIG. 6 shows a detail 20 of an interior of a vehicle 22 having the tambour cover 2.

The interior 20 has a coverable region 24. In the present case, the coverable region 24 is a storage place. The displaceable, windable tambour cover 2 is designed for covering the coverable region 24.

The tambour cover 2 is guided in a form-fitting manner in opposite grooves 26 of the vehicle 22 and is displaceable from an open, at least partially wound-up position into a closed, at least partially unwound position in order to cover or to expose the coverable region 24.

What is claimed is:

1. A tambour cover for an interior of a vehicle, the tambour cover comprising:
a cover layer (4);
a carrier layer (6); and
ribs (8),
wherein the ribs (8) are arranged parallel to one another and spaced apart by a distance (a1),
wherein the cover layer (4) is arranged on a first side (10) of the carrier layer (6),
wherein the ribs (8) are arranged on a second side (12) of the carrier layer (6) facing away from the first side (10),
wherein the carrier layer (6) comprises a soft plastic, and
wherein the ribs (8) comprise a plastic material that is harder than the soft plastic of the carrier layer (6).

2. The tambour cover as claimed in claim 1,
wherein the ribs (8) are arranged at equidistant distances (a1) from one another.

3. The tambour cover as claimed in claim 1,
wherein at least one of the ribs (8) has a longitudinal extent (l1) extending perpendicularly to a direction of displacement (v) of the tambour cover (2).

4. The tambour cover as claimed in claim 1,
wherein the cover layer (4) has a thickness (d1) between 0.1 mm and 1.5 mm.

5. The tambour cover as claimed in claim 4,
wherein a thickness (d2) of the carrier layer (6) is at least twice the thickness (d1) of the cover layer (4) and at most ten times the thickness (d1) of the cover layer (4).

6. The tambour cover as claimed in claim 5,
wherein a thickness (d3) of the ribs (8) is at least twice the thickness (d2) of the carrier layer (6) and at most ten times the thickness (d2) of the carrier layer (6).

7. The tambour cover as claimed in claim 1,
wherein the cover layer (4) comprises a polycarbonate or consists of a polycarbonate.

8. The tambour cover as claimed in claim 1,
wherein the cover layer (4) and/or the carrier layer (6) are/is elastically and reversibly deformable, and/or
wherein the ribs (8) are inelastic and are not reversibly deformable, and/or
wherein the cover layer (4) and the carrier layer (6) are adhesively bonded to each other, and/or
wherein the ribs (8) and the carrier layer (6) are connected to each other with an integral bond.

9. The tambour cover as claimed in claim 1,
wherein the ribs (8) comprise one or more of acrylonitrile-butadiene-styrene copolymer, polycarbonate, and polyamide, and/or
wherein the ribs (8) comprise a fiber reinforced plastic or are made from a fiber reinforced plastic.

10. The tambour cover as claimed in claim 1,
wherein the ribs (8) have a substantially trapezoidal cross section which tapers in a direction pointing away from the cover layer (4) and the carrier layer (6), and/or
wherein the ribs (8) have, at ends facing away from each other, guide sections (14) protruding beyond a width (b1) of the cover layer (2) and the carrier layer (6), the guide sections (14) being provided for form-fitting engagement in mutually opposite guide grooves (26) formed in the interior (20) of the vehicle (22).

11. The tambour cover as claimed in claim 1,
wherein the carrier layer (6) comprises a thermoplastic or consists of a thermoplastic.

12. The tambour cover as claimed in claim 1,
wherein the cover layer (4) is a cover film.

13. The tambour cover as claimed in claim 1,
wherein the carrier layer has a thickness between 0.5 mm and 1.5 mm.

14. A vehicle, comprising:
an interior (20) for receiving people to be conveyed, the interior (20) including
a coverable region (24) being a storage place, a compartment, a holder, a window, a screen, or an operating element, and
a displaceable, windable tambour cover (2) for covering the coverable region (24),
wherein the tambour cover (2) is displaceable from an open, at least partially wound up position into a closed, at least partially unwound position, and
wherein the tambour cover (2) comprises
a cover layer (4);
a carrier layer (6); and
ribs (8),
wherein the ribs (8) are arranged parallel to one another and spaced apart by a distance (a1),
wherein the cover layer (4) is arranged on a first side (10) of the carrier layer (6),
wherein the ribs (8) are arranged on a second side (12) of the carrier layer (6) facing away from the first side (10),
wherein the carrier layer (6) comprises a soft plastic, and
wherein the ribs (8) comprise a plastic material that is harder than the soft plastic of the carrier layer (6).
